(19) United States
(12) Patent Application Publication
(10) Pub. No.: US 2025/0263024 A1
(43) Pub. Date: Aug. 21, 2025

(54) Sensor Assembly for a Motor Vehicle, and Mirror Assembly Comprising Such a Sensor Assembly

(71) Applicant: Bayerische Motoren Werke Aktiengesellschaft, Muenchen (DE)

(72) Inventor: Lucien STEMMELEN, Vierkirchen (DE)

(21) Appl. No.: 19/101,832

(22) PCT Filed: Jun. 26, 2023
(86) PCT No.: PCT/EP2023/067292

§ 371 Date: Feb. 6, 2025

(30) Foreign Application Priority Data
Aug. 9, 2022 (DE) 10 2022 120 051.5

(51) Int. Cl. B60R 11/04; B60R 1/12; B60R 11/00

(52) U.S. Cl. CPC B60R 11/04; B60R 1/12; B60R 2001/1223; B60R 2001/1253; B60R 2011/0026

(57) ABSTRACT

A sensor assembly for a motor vehicle. The sensor assembly is fixable to a windshield of the motor vehicle. The sensor assembly has a mounting, a camera, and a rain/light/solar/condensation sensor with a body and a lateral protrusion. The lateral protrusion has an opening via which to measure air humidity. The longitudinal extension direction of the lateral protrusion runs diagonally to a central longitudinal plane of the sensor assembly.

### BACKGROUND AND SUMMARY

The present invention relates to a sensor assembly for a motor vehicle and to a mirror assembly comprising such a sensor assembly.

Mirror assemblies comprising sensor assemblies are known from the prior art in various configurations.

EP 2 195 214 B1 describes a mirror assembly for a motor vehicle, comprising a sensor assembly and a support. The sensor assembly is arranged on the support on the passenger compartment side abutting a windshield of the motor vehicle and comprises a rain/light/solar/condensation sensor and a camera-based driver assistance system. The rain/light/solar/condensation sensor has an opening for introducing and letting out air for the purpose of measuring humidity.

To ensure accurate measurement of the humidity in the interior of the motor vehicle, it is necessary for the opening to be located at least partly in an airflow area of a vehicle ventilation system. At the same time, the camera-based driver assistance system must not to be covered by the rain/light/solar/condensation sensor in order for data to be captured.

In order to meet these requirements, EP 2 195 214 B1 proposes arranging the rain/light/solar/condensation sensor laterally to the camera-based driver assistance system in the transverse direction.

However, due to certain installation space conditions, such an arrangement of the rain/light/solar/condensation sensor and the camera-based driver assistance system is sometimes not able to be realized or at least is able to be realized only with a high degree of outlay.

Proceeding from the mirror assembly described in EP 2 195 214 B1, it is the object of the present invention to provide a sensor assembly for a motor vehicle and a mirror assembly comprising such a sensor assembly that ensures the function of a rain/light/solar/condensation sensor and a camera with a small installation space requirement.

This object is achieved according to the invention by way of the sensor assembly having the features described herein and by way of the mirror assembly having the features described herein.

The invention thus provides a sensor assembly for a motor vehicle that is able to be fixed to a windshield of the motor vehicle. The sensor assembly comprises a mount, a camera, and a rain/light/solar/condensation sensor with a body and a lateral protrusion. The lateral protrusion has an opening for measuring humidity. The longitudinal extent of the lateral protrusion, that is to say the extent of the lateral protrusion away from the body, runs diagonally, that is to say obliquely or transversely, to a central longitudinal plane of the sensor assembly.

In a functional installation state of the sensor assembly on the windshield, the central longitudinal plane of the sensor assembly corresponds for example to the central longitudinal plane of the windshield.

The core idea of the invention is thus to arrange the rain/light/solar/condensation sensor in such a way that the direction of longitudinal extent of the lateral protrusion deviates from a direction of extent of the central longitudinal plane, in particular encloses a defined angle with the central longitudinal plane. This makes it possible to offset the rain/light/solar/condensation sensor in the longitudinal direction of the sensor assembly and arrange same at least partly in a position corresponding to the position of the camera in the transverse direction, wherein the opening provided at the lateral protrusion is still arranged laterally to the rain/light/solar/condensation sensor in the transverse direction due to the diagonal extent of the lateral protrusion and is thus located at least partly in an airflow area of a ventilation system of the motor vehicle.

In a functional installation state of the sensor assembly on the windshield, the longitudinal direction of the sensor assembly corresponds for example to a longitudinal direction of the windshield.

In a functional installation state of the windshield in the motor vehicle, the longitudinal direction of the windshield extends in the longitudinal direction of the motor vehicle and/or in the vertical direction of the motor vehicle depending on the installation position of the windshield on the motor vehicle.

The opening is for example an air circulation opening for introducing and letting out air for operation of the rain/light/solar/condensation sensor.

The optical sensor is for example a camera.

The optical sensor may be part of a camera-based driver assistance system.

In a preferred embodiment of the sensor assembly according to the invention, the opening is partly or fully arranged laterally to the camera in the transverse direction.

In a functional installation state of the sensor assembly in the motor vehicle, the transverse direction corresponds to the transverse direction of the motor vehicle.

The body of the rain/light/solar/condensation sensor is for example in the shape of a flat cylinder.

In one exemplary embodiment of the sensor assembly according to the invention, a straight line along the direction of longitudinal extent of the lateral protrusion and the central longitudinal plane enclose an angle of 20 degrees to 160 degrees.

For example, the direction of longitudinal extent of the lateral protrusion and the central longitudinal plane enclose an angle of 20 degrees to 50 degrees, in particular 30 degrees to 45 degrees.

The direction of longitudinal extent of the lateral protrusion may point forwards in the longitudinal direction.

In a preferred embodiment of the sensor assembly according to the invention, the opening is formed at a first end of the lateral protrusion opposite the body or at a first side wall of the lateral protrusion.

The first side wall may be the lower and/or front side wall of the lateral protrusion in the longitudinal direction.

For example, the first side wall is the side wall of the lateral protrusion facing the camera.

The lateral protrusion may be formed at the first end of the lateral protrusion if the lateral protrusion runs away from the body forwards in the longitudinal direction, that is to say an angle between the straight line along the direction of longitudinal extent of the lateral protrusion and the central longitudinal plane is less than 90 degrees, in particular less than 45 degrees. This ensures that the opening is arranged in the airflow area of the ventilation system.

If the lateral protrusion extends orthogonally to the central longitudinal plane or if an angle between the straight line along the direction of longitudinal extent of the lateral protrusion and the central longitudinal plane is greater than 45 degrees, in particular is greater than or equal to 90 degrees, the lateral protrusion is formed for example at the side wall of the lateral protrusion facing the camera. This ensures that the opening is located in the airflow area of the ventilation system.

In an advantageous embodiment of the sensor assembly according to the invention, the rain/light/solar/condensation sensor comprises a connector holder.

The connector holder may be arranged at a side of the body, in particular the lateral surface of the body, opposite the lateral protrusion.

In a preferred embodiment of the sensor assembly according to the invention, the mount is able to be connected to the windshield via a sealing lip in such a way that an airtight cavity is formed between the mount and the windshield, in which cavity the optical sensor is arranged.

In an exemplary embodiment of the sensor assembly according to the invention, the opening is party, in particular fully, arranged laterally to the airtight cavity and/or the sealing lip in the transverse direction.

In a preferred embodiment of the sensor assembly according to the invention, the rain/light/solar/condensation sensor is arranged behind the camera in the longitudinal direction.

An arrangement of the rain/light/solar/condensation sensor behind the camera in the longitudinal direction may, depending on an installation location of the windshield in the motor vehicle, be a position behind the camera in the longitudinal direction of the motor vehicle and/or vehicle above the camera in the vertical direction of the motor.

In an exemplary embodiment of the sensor assembly according to the invention, the rain/light/solar/condensation sensor, in particular the body thereof, at least partly, in particular fully, has the same position in the transverse direction as the optical sensor, as the airtight cavity, as the sealing lip and/or as subregions of the aforementioned elements.

This means that, when viewed from the front in the longitudinal direction, at least part of the rain/light/solar/condensation sensor may be covered by the camera.

The invention furthermore relates to an interior mirror assembly, in particular a rearview mirror assembly, for a motor vehicle, comprising a mirror, a mirror base, and a sensor assembly as described in the preceding text. The mirror is fixed to a mirror baseplate via the mirror base. The mirror base is able to be fixed to a windshield of the motor vehicle via the mirror baseplate.

The invention is explained in more detail below with reference to one or more exemplary embodiments illustrated in the Figures.

### BRIEF DESCRIPTION OF THE DRAWINGS

FIG. 1 shows a front view of an interior mirror assembly according to the invention; and

FIG. 2 shows a side view of the interior mirror assembly from FIG. 1 together with a windshield.

### DETAILED DESCRIPTION OF THE DRAWINGS

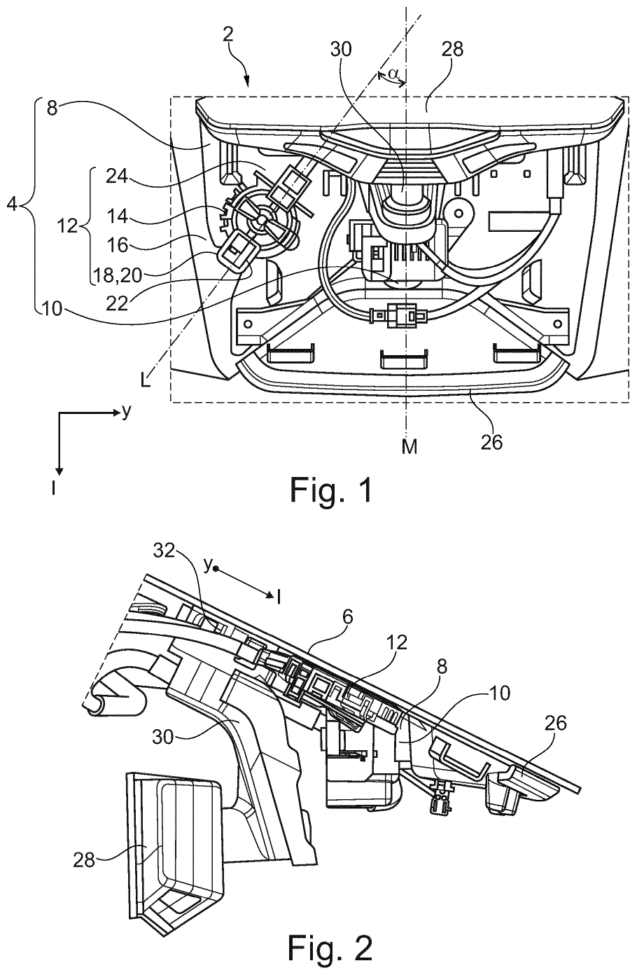

FIGS. 1 and 2 illustrate an interior mirror assembly 2 for a motor vehicle according to the invention. The interior mirror assembly 2 is able to be fixed to a windshield 6 of the motor vehicle.

The interior mirror assembly 2 comprises a mirror 28, a mirror base 30, and a sensor assembly 4. The sensor assembly 4 comprises a mount 8, a camera 10 for a camera-based driver assistance system, and a rain/light/solar/condensation sensor 12. The mirror 28 is fixed to a mirror baseplate 32 via a mirror base 30 and to the windshield 6 via the mirror baseplate 32. The mount 8 comprises a recess, in which the mirror baseplate is arranged.

As can be seen in particular from FIG. 1, the mount 8 holds the camera 10 and the rain/light/solar/condensation sensor 12. To this end, the mount 8 comprises notches in which the optical sensor 10 and the rain/light/solar/condensation sensor 12 are able to be arranged in a defined alignment. The camera 10 is arranged in this case in a front region of the sensor assembly 4 in the longitudinal direction I of the sensor assembly 4. The rain/light/solar/condensation sensor 12 is located behind the camera 10 in the longitudinal direction I.

In a functional installation state of the interior mirror arrangement 2 on the windshield 6, the longitudinal direction I of the sensor assembly 4 extends in the vertical direction of the motor vehicle and the longitudinal direction of the motor vehicle.

In an area surrounding the camera 10, the mount 8 is connected to the windshield 6 via a sealing lip 26. The mount 8, together with the sealing lip 26 and the windshield 6, thus defines an airtight space in which the camera 10 is arranged.

The rain/light/solar/condensation sensor 12 comprises a body 14, a lateral protrusion 16, and a connector holder 24. The body 14 is in the shape of a flat cylinder. The lateral protrusion 16 and the connector holder 24 are arranged on opposite sides of the lateral surface of the body 14.

The rain/light/solar/condensation sensor 12 is arranged behind the camera 10 and the sealing lip 26 in the longitudinal direction I such that the body 14 and the connector holder 24 are covered by the camera 10 and the sealing lip 26 as viewed from the front in the longitudinal direction I. The body 14 and the connector holder 24 thus have the same position in the transverse direction y as a subregion of the camera 10 and/or a subregion of the sealing lip 26.

At a first end 20 remote from the body 14, the lateral protrusion 16 comprises an opening 18 for measuring humidity. In order to thus ensure that enough air from an airflow of a vehicle ventilation n system can flow through the opening 18 into the rain/light/solar/condensation sensor 12 and out of the rain/light/solar/condensation sensor 12 for the purpose of measuring humidity, the rain/light/solar/condensation sensor 12 is rotated by an angle α about an axis of rotation running orthogonally to the windshield 6, starting from an arrangement in which a direction of longitudinal extent L of the lateral protrusion 16 corresponds to a central longitudinal plane M of the interior mirror assembly 2. A straight line along the direction of longitudinal extent L of the lateral protrusion 16 thus runs diagonally, that is to say obliquely or transversely, to the central longitudinal plane M of the interior mirror assembly 2.

In the present case, the angle α is 42 degrees. As a result, the opening 18 is arranged laterally next to the camera 10 and the sealing lip 26 in the transverse direction. The airflow of the vehicle ventilation system can thus flow towards the opening 18 unimpeded.

With an angle of 45 degrees, in order to enable the greatest possible airflow into the opening 18, it may be expedient to arrange the opening 18 at a first side wall 22 that faces forwards in the longitudinal direction I, that is to say faces the camera 10.

### LIST OF REFERENCE SIGNS

2 Interior mirror assembly
4 Sensor assembly
6 Windshield
8 Mount
10 Camera
12 Rain/light/solar/condensation sensor
14 Body
16 Lateral protrusion
18 Opening
20 First end
22 First side wall
24 Connector holder
26 Scaling lip
28 Mirror
30 Mirror base
32 Mirror baseplate
I Longitudinal direction
L Straight line along the direction of longitudinal extent of the lateral protrusion
M Central longitudinal plane
y Transverse direction
α Angle

1-10. (canceled)

11. A sensor assembly for a motor vehicle, comprising:
a mount;
a camera; and
a rain/light/solar/condensation sensor with a body and a lateral protrusion, wherein the lateral protrusion has an opening for measuring humidity,
wherein the sensor assembly is fixable to a windshield of the motor vehicle, and
wherein a straight line along the direction of longitudinal extent of the lateral protrusion runs diagonally to a central longitudinal plane of the sensor assembly.

12. The sensor assembly of claim 11, wherein the opening is partly or fully arranged laterally to the camera in the transverse direction.

13. The sensor assembly of claim 11, wherein the straight line along the direction of longitudinal extent of the lateral protrusion and the central longitudinal plane enclose an angle of 20 degrees to 160 degrees.

14. The sensor assembly of claim 11, wherein the opening is formed at a first end of the lateral protrusion opposite the body or at a first side wall of the lateral protrusion.

15. The sensor assembly of claim 11, wherein the rain/light/solar/condensation sensor comprises a connector holder arranged on a side of the body opposite the lateral protrusion.

16. The sensor assembly of claim 11, wherein the mount is able to be connected to the windshield via a sealing lip in such a way that an airtight cavity is formed between the mount and the windshield, in which cavity the optical sensor is arranged.

17. The sensor assembly of claim 16, wherein the opening is arranged laterally to the airtight cavity and/or the sealing lip in the transverse direction.

18. The sensor assembly of claim 11, wherein the rain/light/solar/condensation sensor is arranged behind the camera in the longitudinal direction.

19. The sensor assembly of claim 11, wherein the rain/light/solar/condensation sensor at least partly has the same position in the transverse direction as at least one subregion of the camera, of the airtight cavity and/or of the sealing lip.

20. An interior mirror assembly for a motor vehicle, comprising:
a mirror;
a mirror base;
a mirror baseplate; and
the sensor assembly of claim 11, wherein the mirror is fixed to the mirror baseplate via the mirror base and the mount comprises a recess in which the mirror baseplate is arranged.
